(19) United States
(12) Patent Application Publication
(10) Pub. No.: US 2018/0321821 A1
(43) Pub. Date: Nov. 8, 2018

(54) METHOD AND APPARATUS FOR BATCH LAYOUT OBJECTS SELECTION AND EDITING VIA A GRAPHIC-BASED LAYOUT EDITOR

(71) Applicant: SKILLCAD, INC., San Jose, CA (US)

(72) Inventor: Pengwei QIAN, San Jose, CA (US)

(21) Appl. No.: 15/589,917

(22) Filed: May 8, 2017

(51) Int. Cl. G06F 3/0484; G06F 3/0482; G06T 11/60; G06F 17/30

(52) U.S. Cl. CPC G06F 3/04842; G06F 3/0482; G06T 11/60; G06T 2210/04; G06F 17/30259; G06T 2200/24; G06F 3/04845

(57) ABSTRACT

A new approach is proposed to support batch layout objects selection and editing via a graphic-based layout editing tool running on a host. Specifically, the layout editing tool presents a plurality of layout objects in a layout on a display of the host and enables a user to directionally and continuously move a cursor across the layout along a single line from a starting point to an ending point, wherein the single line intersects with and selects a group of layout objects. The layout editing tool also identifies the last layout objects intersected by the line as a reference object for the rest of the selected layout objects. The layout editing tool then simultaneously performs an editing operation on the rest of the selected layout objects as a batch using the last layout object as a reference object based on retrieved metadata and/or design rules associated with the layout objects.

### BACKGROUND

A graphic-based layout editing tool/editor is software running on a hosting device or host, wherein the graphic-based layout editor presents a layout to a user/designer on a display screen of the host and enables the user to interactively generate and edit the layout via input devices associated with the host. Here, the layout typically includes hundreds or even thousands of layout objects of various shapes and sizes, including but not limited to blocks, cells, gates, interconnect wires, etc. The layout can be, for non-limiting examples, for an integrated circuit (IC) design or an architectural design.

Each layout object in the layout typically has metadata associated with it, wherein such metadata includes, for non-limiting examples, name, geometric properties (e.g., length, width, size, topology, orientation and connections with other layout objects of the layout) and design rules (e.g., permissible positions, minimum or maximum lengths, widths, and spacing from other layout objects) each layout object needs to follow in the layout. Quite often, a group of layout objects in the layout may share the same shape, size, and location, and often need to be edited together with reference to another layout object or point in the layout. It would be cumbersome to edit each of the layout objects individually one by one (e.g., moving a group of interconnect wire segments in an IC layout one segment at a time following the same set of design rules), especially when the number of the layout objects in the layout is huge. It is thus desirable to have a graphic-based layout editor that can enable the user to edit a group of layout objects have the same or similar properties in the layout simultaneously as a batch.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to support batch layout objects selection and editing in accordance with some embodiments.

FIG. 2 depicts a non-limiting example of an IC layout having a plurality of interconnect wires as shown on a display of a host in accordance with some embodiments.

FIG. 3A depicts an example of directional and continuous cursor movement along a single line from a starting point to an ending point in a layout, wherein the last layout object the cursor stops at is identified as the reference layout object of the rest of the layout objects intersected and selected by the single line of continuous cursor movement in accordance with some embodiments.

FIG. 3B depicts an example of a compacting operation performed simultaneously on the selected layout objects as shown by the example depicted in FIG. 3A as a batch, wherein the spacing between the group of selected layout objects is reduced to the minimum with respect to the reference layout object as required for their design rules in accordance with some embodiments.

FIG. 4A depicts an example of directional and continuous cursor movement along a single line across a layout, wherein the ending point of the single line stops in an open space area of the layout and the ending point is identified as the reference point in accordance with some embodiments.

FIG. 4B depicts an example of a layout objects moving operation performed simultaneously on the selected layout objects shown by the example depicted in FIG. 4A as a batch with respect to the reference point, wherein the group of layout objects is moved towards the reference point as a group while maintaining the spacing between them as required by their design rules in accordance with some embodiments.

FIG. 5A depicts an example of a group of layout objects in a layout selected by a single line in accordance with some embodiments, wherein the group of selected layout objects connect to a group of other layout objects.

FIG. 5B depicts an example of a wire sizing operation performed simultaneously on the group of selected layout objects shown by the example depicted in FIG. 5A as a batch in accordance with some embodiments.

FIG. 6 depicts an example of a flowchart of a process to support batch layout objects selection and editing in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support batch layout objects selection and editing via a graphic-based layout editing tool running on a host. Specifically, the graphic-based layout editing tool presents a plurality of layout objects in a layout on a display of the host and enables a user to directionally and continuously move a cursor across the layout along a single line from a starting point to an ending point, wherein the single line intersects with and selects a group of layout objects. The graphic-based layout editing tool also identifies the last layout objects intersected by the single line as a reference object for the rest of the selected layout objects. After retrieving metadata and/or design rules associated with the group of selected layout objects, the graphic-based layout editing tool simultaneously performs an editing operation on each of the rest of the selected layout objects as a batch using the last layout object as a reference object based on the retrieved metadata and/or design rules associated with the layout objects. The graphic-based layout editing tool then presents the group of edited layout objects on the display following the editing operation.

By allowing the user to move the cursor continuously across the layout in the single directed line for layout objects selection, the proposed graphic-based layout editing tool enables the user to select the group of layout objects in a sequence where the last layout object selected by the user can be identified and distinguished from the rest of the selected layout objects. The proposed graphic-based layout editing tool may then utilize the metadata and/or design rules associated with the last layout object as reference and perform the edit operation to the rest of the selected objects in a batch instead of one by one. As such, the proposed graphic-based layout editing tool enables the user to perform batch selection and editing on a group of layout objects that share the same or similar properties and greatly improves the efficiency of layout editing.

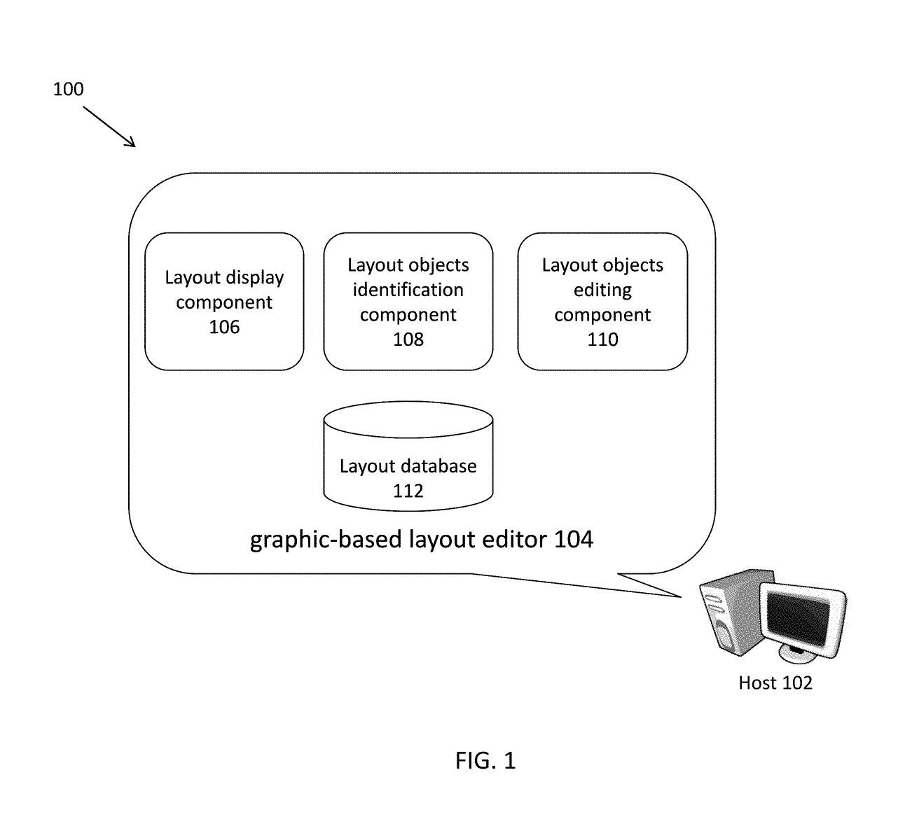

FIG. 1 depicts an example of a diagram of a system 100 to support batch layout objects selection and editing. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, wherein the multiple hosts can be connected by one or more networks.

In the example of FIG. 1, the system 100 includes a graphic-based layout editor/editing tool/editing software 104, wherein the graphic-based layout editor 104 includes at least a layout display component 106, a layout objects identification component 108, a layout objects editing component 110, and a layout database 112. Here, the graphic-based layout editor 104 runs on a computing unit/appliance/host 102 having a display, one or more processors, storage units, network interfaces and having software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units of the computing unit, which becomes a special purposed one for practicing the processes. The processes may also be at least partially embodied in the host into which computer program code is loaded and/or executed, such that, the host becomes a special purpose computing unit for practicing the processes. Here, the host can be a computing device, a communication device, a storage device, or any computing device capable of running a software component. For non-limiting examples, a computing device can be, but is not limited to, a laptop PC, a desktop PC, a tablet PC, or an x86 or ARM-based server running Linux or other operating systems. In some embodiments, the host has a communication interface (not shown), which enables the components and/or the database running on the host to communicate with software running on other host over one or more communication networks (not shown) following certain communication protocols, such as TCP/IP, http, https, ftp, and sftp protocols. The communication networks can be, but are not limited to, internet, intranet, wide area network (WAN), local area network (LAN), wireless network, Bluetooth, WiFi, and mobile communication network. The physical connections of the network and the communication protocols are well known to those of skill in the art.

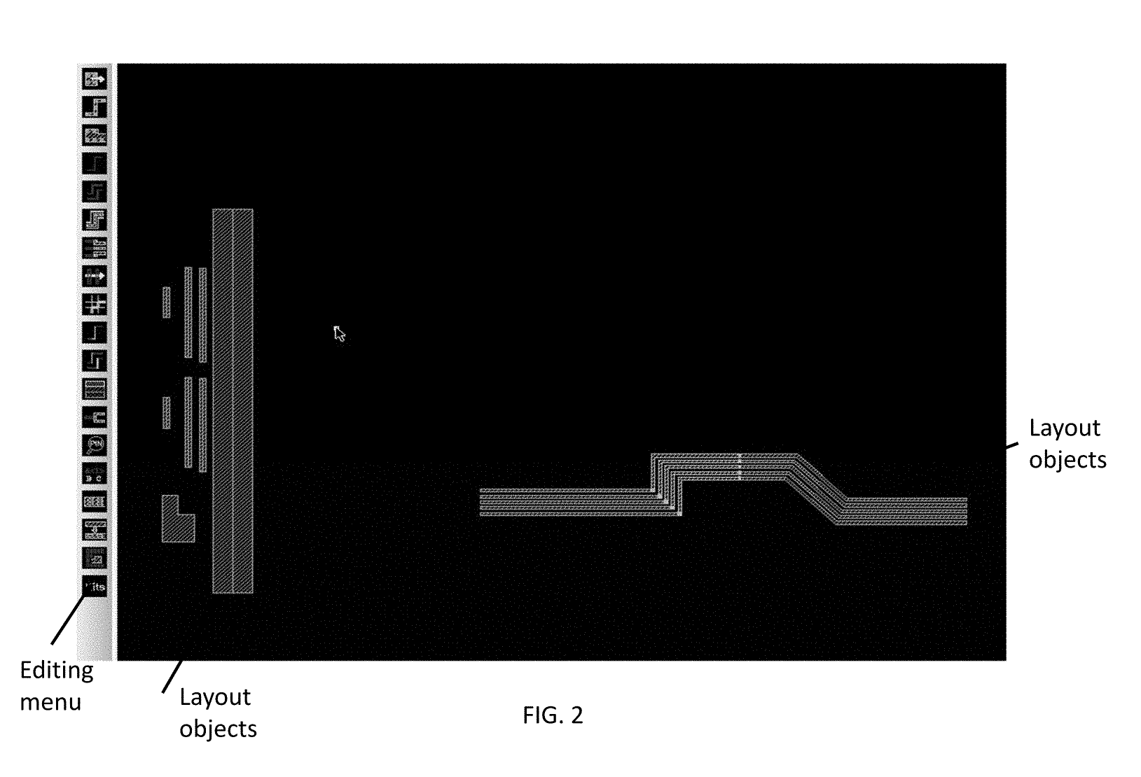

In the example of FIG. 1, the layout display component 106 of the graphic-based layout editor 104 is configured to retrieve a layout having a plurality of layout objects from the layout database 112 and present the layout on a display device of the host of the graphic-based layout editor 104 for a user to view and edit interactively. Here, the layout database 112 is configured to maintain metadata and/or design rules associated with each of the layout objects in the layout as well as other related information of the layout. Each of the layout objects is of certain geometric shape/topology and size, which, for non-limiting examples, can be a rectangle, a circle, a polygon, etc. In the non-limiting example of an IC layout having multiple layers, the layout objects can be cells, gates, and interconnect wires of different material types (e.g., metal and polysilicon) on one or more layers and can be presented accordingly with different colors representing the different types and layers by the layout display component 106. FIG. 2 depicts a non-limiting example of an IC layout having a plurality of interconnect wires shown by the layout display component 106 on a display of a host. FIG. 2 also depicts a menu of editing operations presented by the layout display component 106 to the user, who may selectively perform one or more editing operations on the presented layout objects via the menu of editing operations.

In some embodiments, each of the layout objects may have metadata associated with it, wherein the metadata includes, for non-limiting examples, one or more of name, identifier, and geometric properties of the layout object as well as its connections to other layout objects. In the case of an IC design layout object, the layout object may further include various design rules required for the layout object, wherein such design rules may include, for non-limiting examples, one or more of minimum and/or maximum width and/or length of the layout object, minimum and/or maximum spacing between the layout object and its adjacent layout objects, and a specific layer the layout object needs to be placed. In some embodiments, the design rules are pre-defined for the layout object based on its properties. In some embodiments, the design rules can be dynamically adjusted by the user via the graphic-based layout editor 104 during editing of the layout.

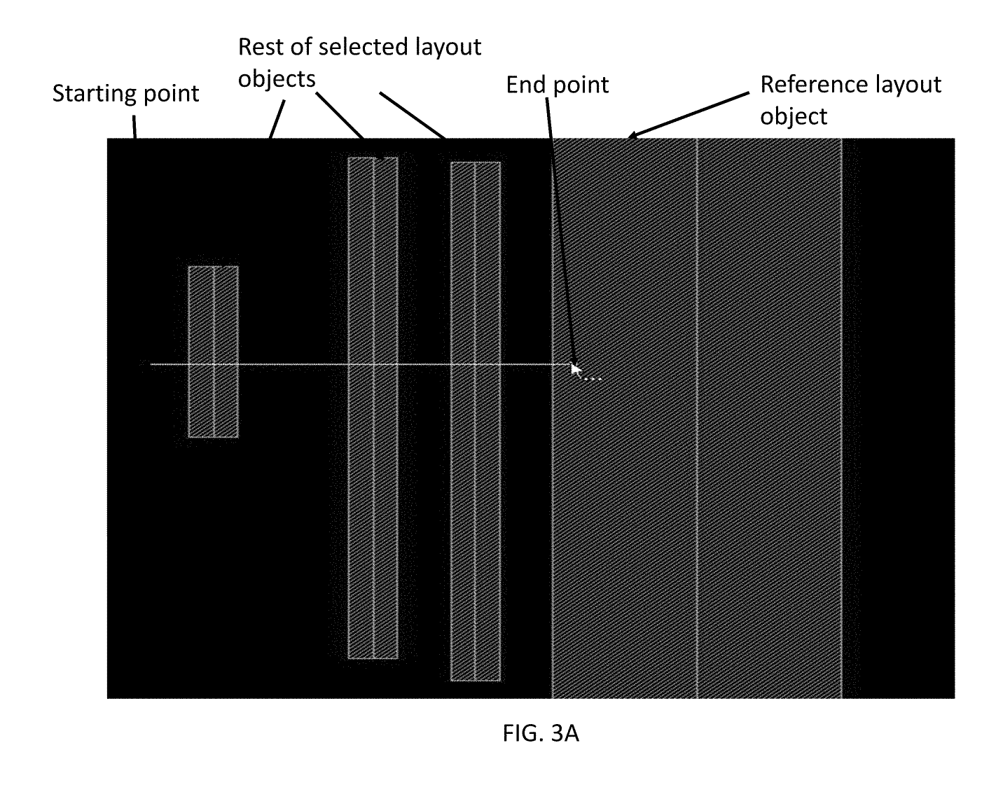

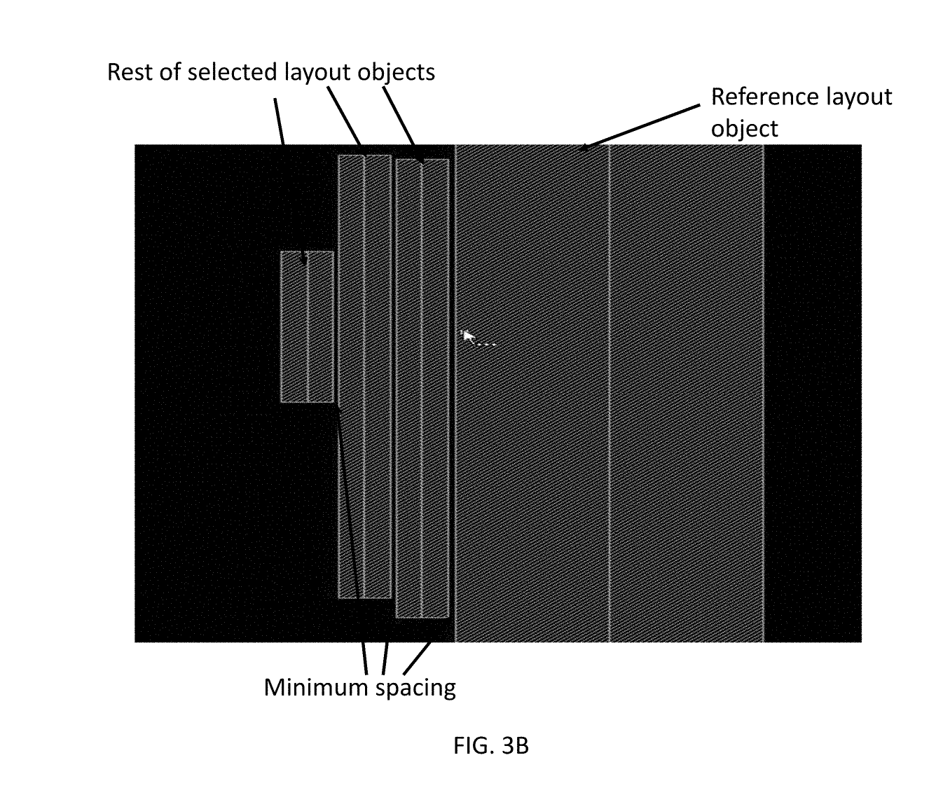

In the example of FIG. 1, the layout objects identification component 108 of the graphic-based layout editor 104 is configured to recognize a directional and continuous cursor movement by a user along a single line from a starting point to an ending point in the layout, wherein the single line intersects with a group (n) of layout objects among the plurality of layout objects in the layout. Here, the user may initiate and perform the cursor movement via an input device (e.g., a mouse) of the host or by moving his/her finger across a touch screen of the host. The single line of directional continuous movement from the starting point to the ending point across the layout can be in one of a directed straight line, a directed curved line, or a directed line following a path of cursor movement across the layout. Since the continuous cursor movement is directional from the starting point to the ending point, the layout objects identification component 108 is configured to identify the last layout object among the group of layout objects intersected by the single line (or at which the ending point of the line stops/resides) as a reference layout object for the rest (n−1) of the selected layout objects. FIG. 3A depicts an example of directional and continuous cursor movement along a single line from a starting point to an ending point in a layout, wherein the last layout object (interconnect wire segment) the cursor stops at is identified as the reference layout object of the rest (n−1) of the layout objects (interconnect wire segments) intersected and selected by the single line of directional and continuous cursor movement.

Once the group of layout objects has been selected via the directional and continuous cursor movement, the layout objects editing component 110 of the graphic-based layout editor 104 is configured to retrieve metadata and/or one or more design rules associated with the group of selected layout objects from the layout database 112. The layout objects editing component 110 is then configured to perform an editing operation on each of the rest (n−1) of the selected layout objects simultaneously as a batch using the last layout object as the reference layout object based on the retrieved metadata and/or design rules associated with the layout objects. Here, the editing operation on the group of object can be chosen by the user via the editing menu of the graphic-based layout editor 104 presented to the user and can be, for non-limiting examples, moving the layout objects, adjusting geometric properties (e.g., length, width, size, shape or topology) of each of the layout objects and/or spacing or relative positioning among the layout objects according to the design rules. FIG. 3B depicts an example of a compacting operation performed simultaneously on the rest of the selected layout objects as shown by the example depicted in FIG. 3A as a batch, wherein the spacing between the group of selected layout objects is reduced to the minimum with respect to the reference layout object as required for their design rules. Note that the minimum spacing between different adjacent pair of layout objects may be different depending on their design rules. In the example of FIG. 3B, the minimum spacing between the last/reference layout object and its adjacent layout object is larger than the minimum spacing between other pairs of adjacent layout objects due to the fact that the last layout object is wider than the other layout objects and thus requires larger minimum spacing with others under its design rules.

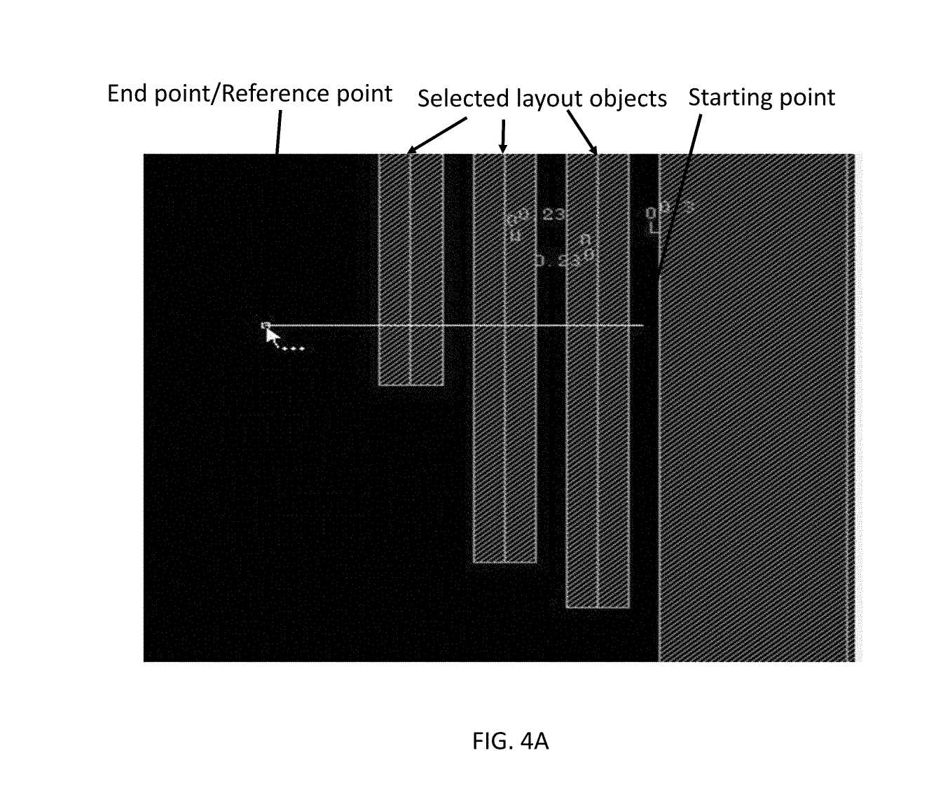

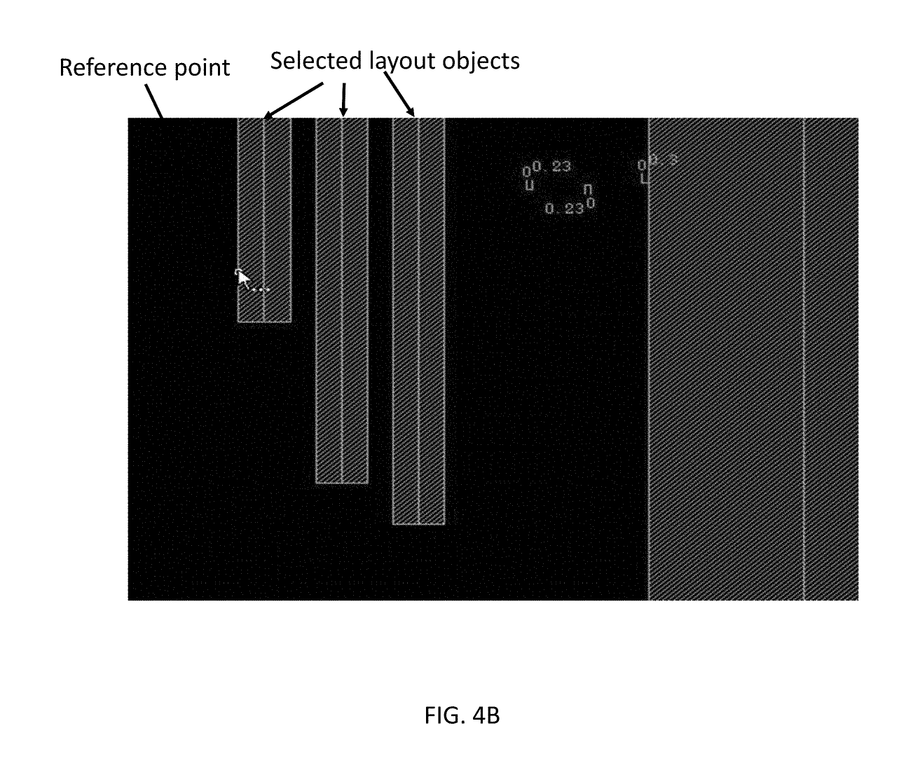

In some embodiments, instead of identifying the reference layout object, the layout objects identification component 108 of the graphic-based layout editor 104 is configured to identify the ending point of the single line of directional and continuous cursor movement as a reference point for editing of the group of selected layout objects if the single line stops at an open area of the layout instead of at a layout object. Under such scenario, the layout objects editing component 110 of the graphic-based layout editor 104 is configured to perform an editing operation on each of the selected layout objects simultaneously as a batch with respect to the reference point based on the retrieved metadata and/or design rules associated with the layout objects. FIG. 4A depicts an example of directional and continuous cursor movement along a single line across a layout, wherein the ending point of the single line stops in an open area of the layout instead of a layout object and the ending point is identified as the reference point. FIG. 4B depicts an example of a layout objects moving operation performed simultaneously on the selected layout objects shown by the example depicted in FIG. 4A as a batch with respect to the reference point, wherein the group of layout objects is moved towards the reference point as a group while maintaining the spacing between them as required by their design rules.

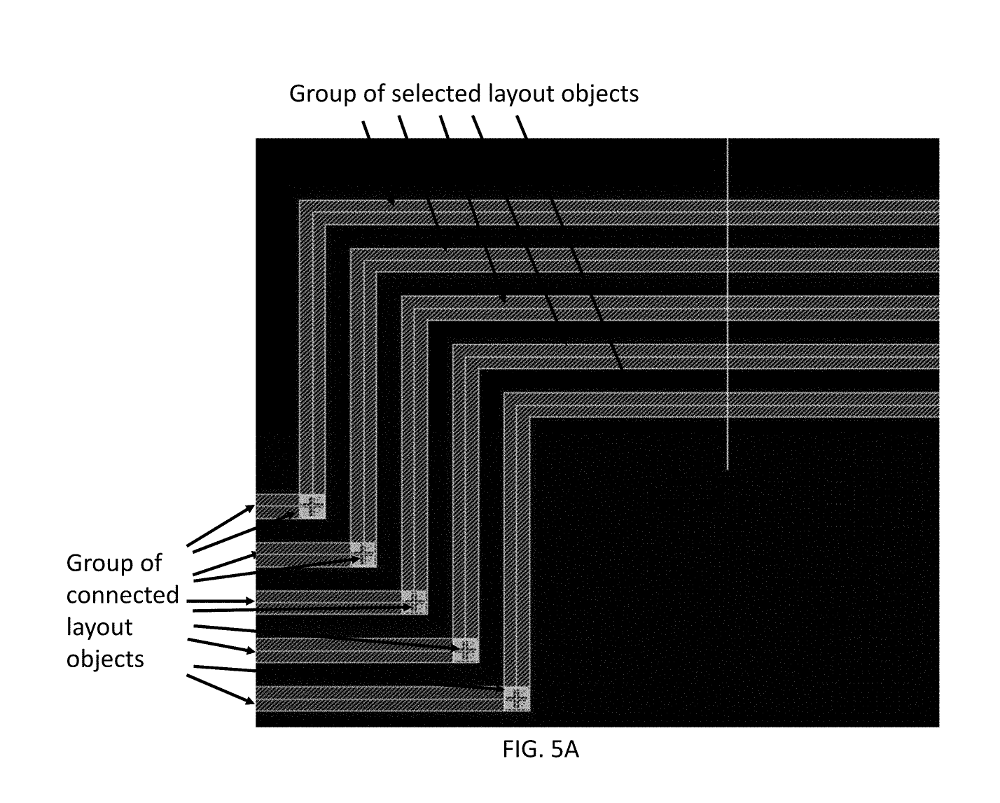

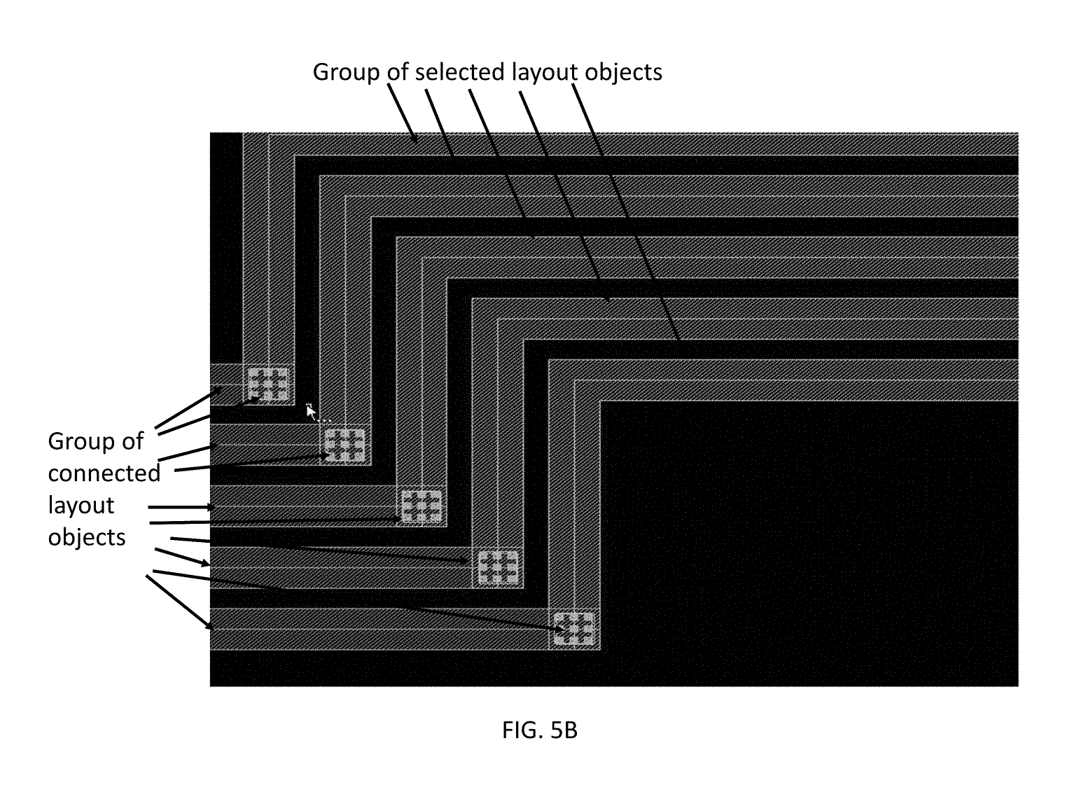

In some embodiments, the layout objects editing component 110 of the graphic-based layout editor 104 is configured to identify a group of layout objects connected to the group of selected layout objects and perform the edit operation not only on the group of selected layout objects, but also on the group of layout objects connected to the selected layout objects if same or similar changes are required for those connected layout objects under their design rules. FIG. 5A depicts an example of a group of layout objects (interconnect wire segments) in a layout selected by a single line, wherein the group of selected layout objects connect to a group of other layout objects—a group of interconnect wire segments on a separate layer and vias connecting the two groups of interconnect wire segments together. FIG. 5B depicts an example of a wire sizing operation performed simultaneously on the group of selected layout objects shown by the example depicted in FIG. 5A as a batch. In addition to adjusting the wires sizes of the group of selected layout objects, the wire and via sizes of the group of interconnect wire segments and vias connected to the selected group of layout objects are also adjusted accordingly according to their design rules.

Once the batch editing operation on the selected layout objects is completed, the layout display component 106 is configured to present the layout including the edited group of selected layout objects on the display, update the metadata of each of the layout objects whose geometric properties (e.g., width, size, shape/topology, spacing, location, and/or connections) have changed, and save the edited layout objects to the layout database 112 together with their updated metadata.

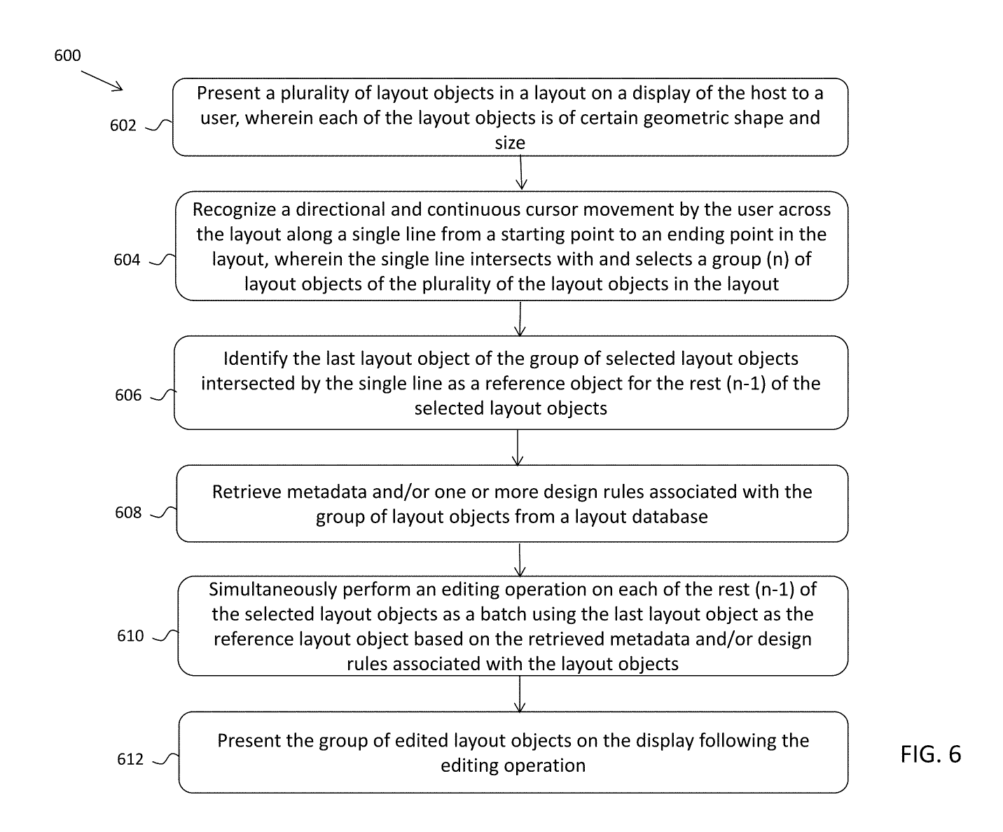

FIG. 6 depicts an example of a flowchart of a process to support batch layout objects selection and editing. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 6, the flowchart 600 starts at block 602, where a plurality of layout objects in a layout is presented on a display of the host to a user, wherein each of the layout objects is of certain geometric shape and size. The flowchart 600 continues to block 604, where a directional and continuous cursor movement by the user across the layout along a single line from a starting point to an ending point in the layout is recognized, wherein the single line intersects with and selects a group (n) of layout objects of the plurality of the layout objects in the layout. The flowchart 600 continues to block 606, where the last layout object of the group of selected layout objects intersected by the single line is identified as a reference object for the rest (n−1) of the selected layout objects. The flowchart 600 continues to block 608, where metadata and/or one or more design rules associated with the group of layout objects are retrieved from a layout database. The flowchart 600 continues to block 610, where an editing operation is simultaneously performed on each of the rest (n−1) of the selected layout objects as a batch using the last layout object as the reference layout object based on the retrieved metadata and/or design rules associated with the layout objects. The flowchart 600 ends at block 612, where the group of edited layout objects is presented on the display following the editing operation.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVDs, CD-ROMs, micro drives, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments, and the various modifications that are suited to the particular use contemplated.

What is claimed is:

1. A system to support batch layout objects selection and editing, comprising:
a graphic-based layout editing tool running on a host, which in operation, is configured to
present a plurality of layout objects in a layout on a display of the host to a user, wherein each of the layout objects is of certain geometric shape and size;
recognize a directional and continuous cursor movement by the user across the layout along a single line from a starting point to an ending point in the layout, wherein the single line intersects with and selects a group (n) of layout objects of the plurality of the layout objects in the layout;
identify the last layout object of the group of selected layout objects intersected by the single line as a reference object for the rest (n−1) of the selected layout objects;
retrieve metadata and/or one or more design rules associated with the group of layout objects from a layout database;
simultaneously perform an editing operation on each of the rest (n−1) of the selected layout objects as a batch using the last layout object as the reference layout object based on the retrieved metadata and/or design rules associated with the layout objects;
present the group of edited layout objects on the display following the editing operation.

2. The system of claim 1, further comprising:
said layout database configured to maintain metadata and/or design rules associated with each of the layout objects in the layout.

3. The system of claim 1, wherein:
the metadata of each layout object includes one or more of name, identifier, and geometric properties of the layout object as well as its connections to other layout objects.

4. The system of claim 1, wherein:
the design rules include one or more of minimum and/or maximum width and/or length of the layout object, minimum and/or maximum spacing between the layout object and its adjacent layout objects, a specific layer the layout object needs to be placed.

5. The system of claim 1, wherein:
the single line of directional continuous movement is one of a straight line, a curved line, or a line following a path of movement across the layout.

6. The system of claim 1, wherein:
the graphic-based layout editing tool is configured to enable the user to choose the editing operation on the group of object via an editing menu presented to the user.

7. The system of claim 1, wherein:
the editing operation is one of moving the layout objects, adjusting geometric properties of the layout objects, and adjusting spacing or relative positioning of the layout objects according to the design rules.

8. The system of claim 1, wherein:
the graphic-based layout editing tool is configured to identify the last layout object as the reference layout object based on at which layout object the ending point of the single line stops.

9. The system of claim 1, wherein:
the graphic-based layout editing tool is configured to
identify the ending point of the single line as a reference point for editing of the group of selected layout objects if the single line stops at an open area of the layout instead of identifying the reference layout object;
perform the editing operation on each of the selected layout objects simultaneously as a batch with respect to the reference point based on the retrieved metadata and/or design rules associated with the layout objects.

10. The system of claim 1, wherein:
the graphic-based layout editing tool is configured to
identify a group of layout objects connected to the group of selected layout objects;
perform the edit operation not only on the group of selected layout objects but also on the group of layout objects connected to the selected layout objects if same or similar changes are required for those connected layout objects under their design rules.

11. The system of claim 1, wherein:
the graphic-based layout editing tool is configured to
update the metadata of each of the layout objects whose geometric properties have changed;
save the edited layout objects to the layout database together with their updated metadata.

12. A computer-implemented method to support batch layout objects selection and editing, comprising:
presenting a plurality of layout objects in a layout on a display of the host to a user, wherein each of the layout objects is of certain geometric shape and size;
recognizing a directional and continuous cursor movement by the user across the layout along a single line from a starting point to an ending point in the layout, wherein the single line intersects with and selects a group (n) of layout objects of the plurality of the layout objects in the layout;
identifying the last layout object of the group of selected layout objects intersected by the single line as a reference object for the rest (n−1) of the selected layout objects;
retrieving metadata and/or one or more design rules associated with the group of layout objects from a layout database;
simultaneously performing an editing operation on each of the rest (n−1) of the selected layout objects as a batch using the last layout object as the reference layout object based on the retrieved metadata and/or design rules associated with the layout objects;
presenting the group of edited layout objects on the display following the editing operation.

13. The computer-implemented method of claim 12, further comprising:
maintaining metadata and/or design rules associated with each of the layout objects in the layout in said layout database, wherein the metadata of each layout object includes one or more of name, identifier, geometric properties of the layout object as well as its connections to other layout objects, and the design rules include one or more of minimum and/or maximum width and/or length of the layout object, minimum and/or maximum spacing between the layout object and its adjacent layout objects, a specific layer the layout object needs to be placed.

14. The computer-implemented method of claim 12, wherein:
the single line of directional continuous movement is one of a straight line, a curved line, or a line following a path of movement across the layout.

15. The computer-implemented method of claim 12, further comprising:
enabling the user to choose the editing operation on the group of object via an editing menu presented to the user.

16. The computer-implemented method of claim 12, wherein:
the editing operation is one of moving the layout objects, adjusting geometric properties of the layout objects, and adjusting spacing or relative positioning of the layout objects according to the design rules.

17. The computer-implemented method of claim 12, further comprising:
identifying the last layout object as the reference layout object based on at which layout object the ending point of the single line stops.

18. The computer-implemented method of claim 12, further comprising:
identifying the ending point of the single line as a reference point for editing of the group of selected layout objects if the single line stops at an open area of the layout instead of identifying the reference layout object;
performing the editing operation on each of the selected layout objects simultaneously as a batch with respect to the reference point based on the retrieved metadata and/or design rules associated with the layout objects.

19. The computer-implemented method of claim 12, further comprising:
updating the metadata of each of the layout objects whose geometric properties have changed;
saving the edited layout objects to the layout database together with their updated metadata.

20. A non-transitory computer readable storage medium having software instructions stored thereon that when executed cause a system to:
present a plurality of layout objects in a layout on a display of the host to a user, wherein each of the layout objects is of certain geometric shape and size;
recognize a directional and continuous cursor movement by the user across the layout along a single line from a starting point to an ending point in the layout, wherein the single line intersects with and selects a group (n) of layout objects of the plurality of the layout objects in the layout;
identify the last layout object of the group of selected layout objects intersected by the single line as a reference object for the rest (n−1) of the selected layout objects;
retrieve metadata and/or one or more design rules associated with the group of layout objects from a layout database;
simultaneously perform an editing operation on each of the rest (n−1) of the selected layout objects as a batch using the last layout object as the reference layout object based on the retrieved metadata and/or design rules associated with the layout objects;
present the group of edited layout objects on the display following the editing operation.
